(19) United States
(12) Patent Application Publication
(10) Pub. No.: US 2010/0192389 A1
(43) Pub. Date: Aug. 5, 2010

(54) ELECTRIC CUTTING TOOL

(75) Inventors: Atsuhito Okada, Fuchu-shi (JP); Katsutoshi Kouchiyama, Fuchu-shi (JP)

Correspondence Address: YOUNG & THOMPSON, 209 Madison Street, Suite 500, Alexandria, VA, 22314, US

(73) Assignee: Ryobi Ltd, Fuchu-shi (JP)

(21) Appl. No.: 12/223,820

(22) PCT Filed: Oct. 26, 2006
(86) PCT No.: PCT/JP2006/321359

§ 371 Date: Aug. 11, 2008

(30) Foreign Application Priority Data
Feb. 9, 2006 (JP) 2006-032019

(51) Int. Cl. B23D 47/12; B23D 45/16

(52) U.S. Cl. 30/374; 30/388

(57) ABSTRACT

An electric cutting tool 100 includes: a body portion 2 accommodating a driving portion 6 for rotating a circular saw blade 1 and a power transmission mechanism for transmitting a power of the driving portion to the circular saw blade; and a surface table 5 supporting the body portion 2, in which the circular saw blade 1 is supported by a shaft 1a that is disposed between a shaft 6a of the driving portion 6 and the surface table 5. In such electric cutting tool 100, the power transmission mechanism is provided with a pair of helical gears 7c, 7d arranged on the same shaft, and the paired helical gears 7c, 7d have tooth traces directed in a same direction. According to such structure, in the electric cutting tool 100, thrust load can be reduced.

### FIELD OF THE INVENTION

The present invention relates to an electric cutting tool such as handheld circular saw, and more particularly, to a power transmission mechanism for transmitting power to a circular saw blade.

### BACKGROUND TECHNOLOGY

Conventionally, as an electric cutting tool, for example, a handheld circular saw has been provided. The circular saw connects a driving shaft of a motor and a saw blade to thereby transmit a driving power of the motor to a circular saw blade and rotate the circular saw blade.

As one example of such circular saw, there is provided a structure in which a drive gear mounted to the motor shaft and a final (terminal) gear mounted to the saw blade shaft and meshed with the drive gear are formed from helical gears, respectively, and a bearing receiving a thrust load to be applied to the saw blade shaft is mounted to the saw blade shaft. (refer to following Patent Publication 1).

On the other hand, in order to prevent vibration or noise caused by collision of tooth surfaces of the respective gears, there is also provided an electric tool provided with a bearing member serving as one-way clutch. Furthermore, there is also provided a structure in which a size of an opening, formed to a surface table of the circular saw, through which the circular saw blade projects is made so that an opening width of a front side thereof is smaller than an opening width of a rear side thereof.

Patent Publication 1: Japanese Utility Model Application Laid-open Publication No. HEI 7-31305

### DISCLOSURE OF THE INVENTION

### Problems to be Solved by the Invention

However, as like the circular saw shown in the Patent Publication 1, in a case where the circular saw is provided with a power transmission mechanism formed from a helical gear, since a bearing supporting the helical gear is received with a thrust load, the usable life time thereof tends to be reduced.

In addition, it is convenient to prevent an vibration and noise due to the collision of the tooth surfaces of the respective gears with a mechanism having simple structure.

Furthermore, it is also convenient to provide an easy-to-use electric cutting tool having simple structure by deforming a shape of an opening formed to a surface table of the circular saw.

Then, an object of the present invention is to provide an electric cutting tool for solving the above problems, and particularly, to provide an electric cutting tool provided with a power transmission mechanism capable of reducing a thrust load.

### Means for Solving the Problems

In order to achieve the above object, the electric cutting tool according to the present invention is characterized by comprising: a body portion including a driving portion for rotating a circular saw blade and a power transmission mechanism for transmitting a power of the driving portion to the circular saw blade; and a surface table supporting the body portion, in which the circular saw blade is supported by a shaft that is disposed between a shaft of the driving portion and the surface table, wherein the power transmission mechanism is provided with a pair of helical gears arranged on a same shaft, and the paired helical gears have tooth traces directed in a same direction.

Furthermore, the electric cutting tool according to the present invention is characterized in that the paired helical gears are mounted to an intermediate gear shaft, in which one of the paired helical gears has a tooth trace angle larger than that of another one of the helical gears, and a bearing that receives a thrust load is provided for an end portion of the intermediate gear shaft on another one helical gear side.

Still furthermore, in the electric cutting tool according to the present invention, it is characterized that the paired helical gears are mounted to an intermediate gear shaft, the intermediate gear shaft is provided with a bearing supporting the intermediate gear shaft and receiving a thrust load applied thereto, the bearing is composed of a circular inner race, a circular outer race and a plurality of spherical members disposed between the inner and outer races, and a resisting member for restricting rotation of the inner race is disposed between the inner and outer races.

### Effects of the Invention

According to the present invention, thrust loads generated by the paired helical gears are denied mutually, so that life time of the bearing supporting the shaft on which the helical gears are mounted can be extended.

In addition, according to the present invention, by alternatively changing the tooth race angles of the paired helical gears, the magnitude of the thrust load generated to the shaft to which the helical gears are mounted can be changed. Therefore, by applying no load on one of the shaft ends, it becomes not necessary to locate bearings to both ends of the shaft for receiving the load, thus making compact a product.

Furthermore, according to the present invention, since the rotation of the intermediate gear shaft is restricted, a noise biting the tooth surface due to backlash at the workpiece cutting starting time or finishing time of the circular saw blade can be reduced.

### BRIEF DESCRIPTION OF THE DRAWINGS

FIG. 1 is a front view of a circular saw according to the present invention.

FIG. 2 is a back-side view of the circular saw shown in FIG. 1.

FIG. 3 is a plan view showing a relationship among the circular saw, a surface table, a safety cover and a circular saw blade shown in FIG. 1.

FIG. 4 is a sectional view taken along the line A-A in FIG. 2.

FIG. 5 is a front view, partially cutaway, showing the circular saw shown in FIG. 1

FIG. 6 is an enlarged view showing an arrangement near a power transmission mechanism.

FIG. 7 is an illustrated sectional view of a radial bearing.

### REFERENCE NUMERAL

1 - - - circular saw, 1a - - - saw blade axis, 2 - - - body portion, 5 - - - surface table, 6 - - - motor, 6a - - - motor shaft, 7c - - - first gear, 7d - - - second gear, 14 - - - intermediate gear shaft, 16 - - - bearing, 31 - - - inner race, 32 - - - outer race, 33 - - - ball (spherical member), 34 - - - retainer (holding member), 35 - - - resisting member, 100 - - - circular saw.

### BEST MODE FOR EMBODYING THE INVENTION

Hereunder, an embodiment of an electric cutting tool according to the present invention will be described with reference to the accompanying drawings. Further, embodiments described hereunder show cases in which the electric cutting tool according to the present invention is a handheld-type electric circular saw.

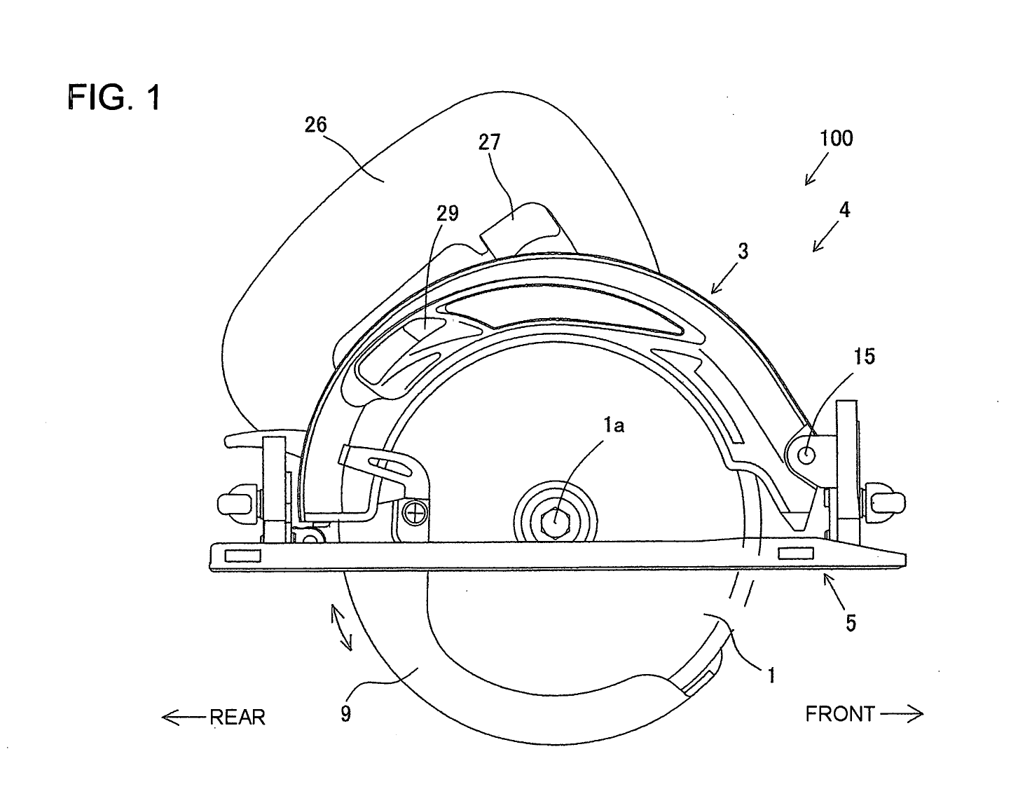

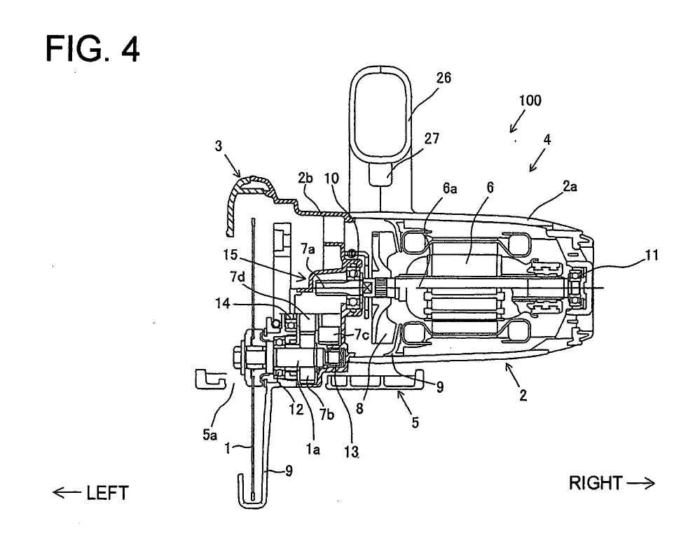

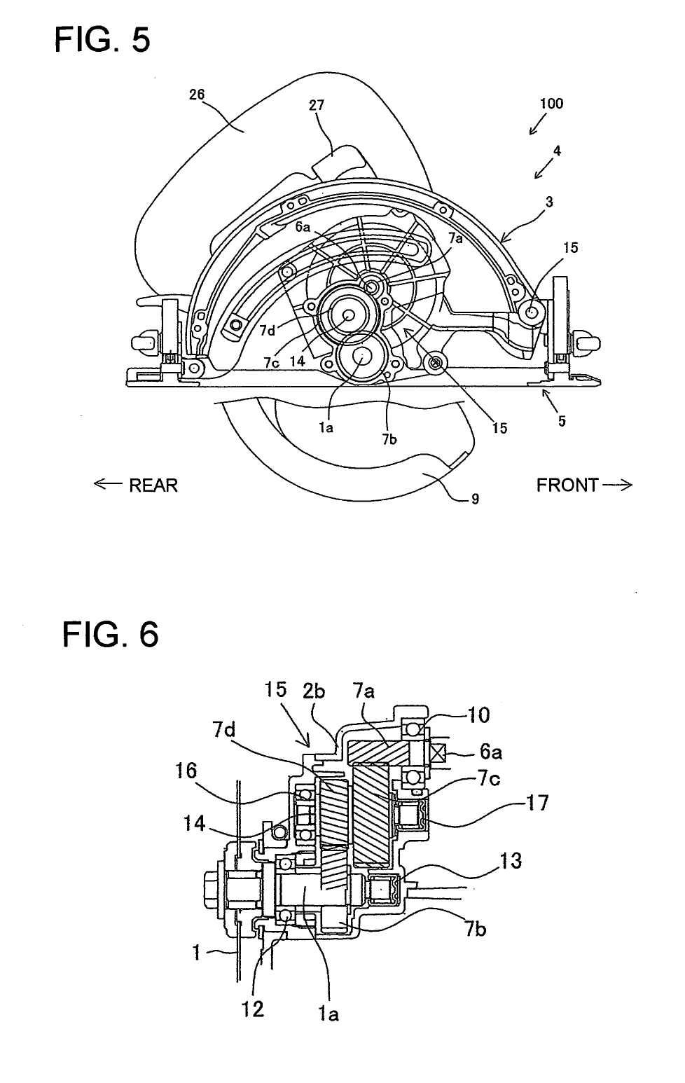

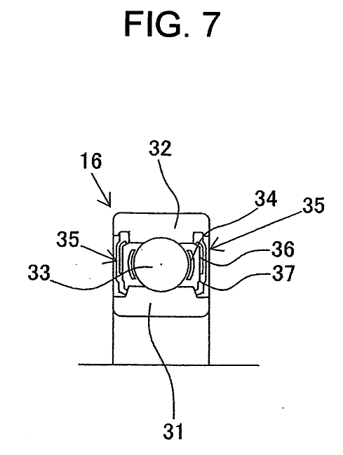

First, a structure of the handheld-type electric circular saw (called hereunder “circular saw 100”) of the present embodiment will be described with reference to FIGS. 1 to 7. Further, herein, for the sake of convenience, left and right direction in FIG. 1 is described as longitudinal direction of the circular saw and left and right direction in FIG. 4 is described as lateral direction of the circular saw.

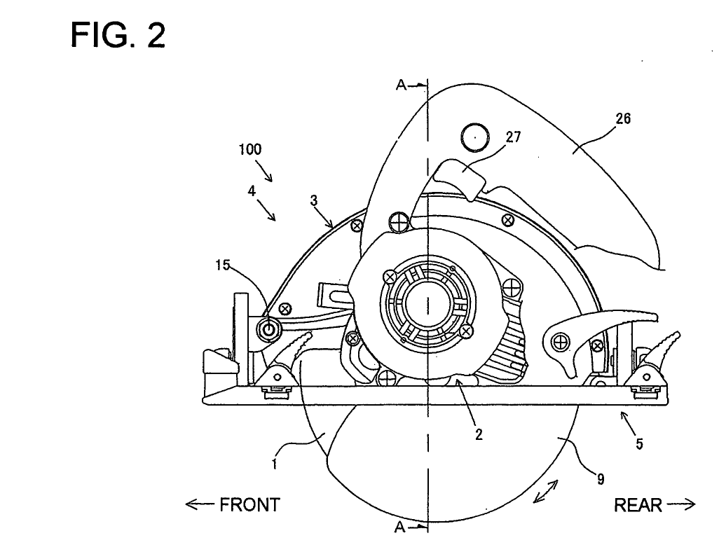

As shown in FIGS. 1 and 2, the circular saw 100 in this embodiment includes: a housing 4 provided with a body portion 2 in which a driving portion for rotationally driving a circular saw blade 1 cutting a workpiece (work to be cut) and a cover portion 3 covering an upper portion of the circular saw blade 1; and a surface table 5 supporting the housing 4.

A handle 26 for operating the circular saw 100 is provided at an upper portion of the housing 4, and a switch lever 27 for rotating the circular saw blade 1 is provided for the handle 26.

Further, as shown in FIG. 1, an opening 29 is formed to a rear side of the cover portion 3, and through this opening 29, a chip (cut chip) produced by the cutting of the circular saw blade 1 at the time of using the circular saw 100 can be discharged outside the cutting tool.

Furthermore, a lower half portion of the circular saw blade 1 is covered by a safety cover 9. When the workpiece is cut, the safety cover 9 is pushed by the workpiece to thereby rotate the circular saw blade 1 around a circular saw blade shaft 1a in an arrowed direction in FIG. 1 and is then accommodated within the cover portion 3.

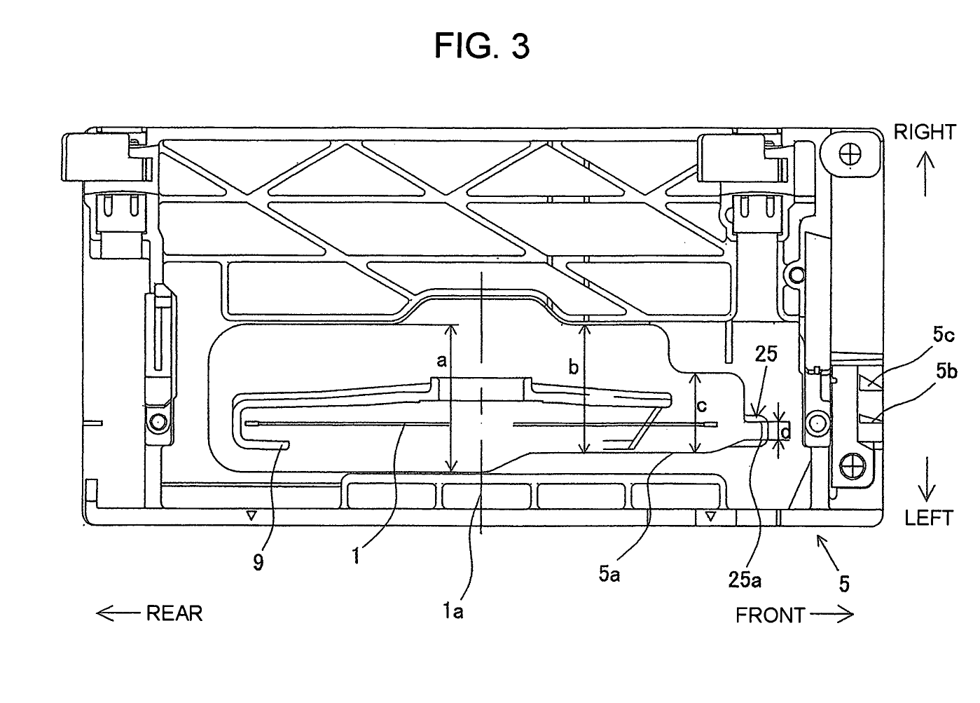

The surface table 5 is disposed below the housing 4 so as to extend in the longitudinal direction of the circular saw 100, and the lower surface of the surface table 5 is formed in a flat surface abutting against the workpiece to be cut. Further, as shown in FIG. 3, a first sight 5b and a second sight 5c for aligning the circular saw blade 1 with a black line showing the cut position of the workpiece are formed in front of the circular saw blade 1 and at the left side front end in front of the surface table 5. These sights 5b and 5c are accorded with the black lines described on the workpiece at the cutting time.

Furthermore, the surface table 5 is formed with an opening 5a through which the circular saw blade 1 or the safety cover 9 passes. The opening 5a is formed such that the width of the opening in front of the rotating shaft 1a of the circular saw blade 1 is gradually narrowed with respect to the width thereof in the lateral direction on the rear side. The opening width is gradually narrowed in four steps “a”, “b”, “c” and “d” in the longitudinal direction as shown in FIG. 3. The width “a” is widened for ensuring a space for mounting the circular saw blade 1 to the saw blade shaft 1a by closely arranging the saw blade shaft 1 near the surface table 5 as shown in FIG. 4, the width “b” on the front side of the width “a” is narrowed in accordance with the size of the cover portion 3. The width “c” on the front side of the width “b” is further narrowed in a range through which the safety cover 9 can pass.

The circular saw 100 provided with the surface table 5 having such opening 5a can effectively prevent the chips from stacking on the surface table 5 because, at the cutting operation, the chips stirred up by the circular saw blade rotating counter-clockwisely as viewed from the left side collide with the lower end portion of the surface table 5.

Further, a portion having the width “d” of the opening 5a, as the final staged portion of the opening, corresponding to a blade tip of the circular saw blade 1 is formed so as to extend in the circumferential direction of the circular saw blade 1. More specifically, the opening portion having the width “d” is continuously formed to the opening 5a of the surface table 5 so as to have an opening portion 25 for visual observation for visually observing a black line on an extending line of the blade tip of the circular saw blade 1 in front of the circular saw 100. The visual observation opening 25 has an outer frame 25a which is chamfered so as to be widened upward, and this opening 25 can be easily observed from the upper side by a user using the circular saw 100. The circular saw 100 of the present embodiment can be easily visually observed through the opening 25. Accordingly, the circular saw 100 of this embodiment can perform the cutting working while observing the position of the black line through the visual observation opening 25.

Furthermore, the surface table 5 is coupled, as shown in FIGS. 1 and 2, with the front end portion of the housing 4 through a pivot shaft 15 so that a rear portion of the housing 4 is pivotal. The rear portion of the housing 4 is vertically tilted with respect to the surface table 5 with the pivotal shaft 15 being fulcrum, and an amount of projection of the circular saw 1 projecting from the lower side of the surface table 5 is adjusted to thereby adjust a cutting depth. Further, the housing 4 can be tilted with respect to the surface table 5, and by tilting the housing 4, the inclination angle of the circular saw blade 1 is adjusted.

As shown in FIG. 4, the body portion 2 of the circular saw 100 includes a cylindrical motor case 2a accommodating a driving portion such as motor 6 for rotating the circular saw in the counter-clockwise direction as viewed from the left side and a cylindrical gear case 2b accommodating a power transmission gear train (gear portion) with respect to the circular saw blade 1 of the driving portion.

The motor case 2a extends in the lateral direction of the circular saw 100 and is horizontally equipped therein with a motor 6. The motor 6 has a motor shaft 6a to which a fan 8 is fixed. The casing 9 covering the outside of the fan 8 is inserted into a cavity of the motor case 2a and fixed thereto. The gear case 2b is disposed so as to abut against the left side end of the motor case 2a as shown and is fixed to the motor case 2a.

As shown in FIGS. 4 to 6, both ends of the motor shaft 6a of the motor 6 are supported by the right end of the gear case 2b and the right end of the motor case 2a through the bearings 11 and 12, respectively. A start-end side gear 7a is provided for the left end of the motor shaft 6a, and this start-end side gear 7a is inserted into the gear case 2b. The bottom portion of the gear case 2b is positioned at a position lower than the bottom surface of the motor case 2a, at which the saw blade shaft 1a of the circular saw blade 1 is supported to the gear case 2b by means of the bearings 12 and 13. According to this arrangement, approximately lower half of the circular saw blade 1 projects over the opening 5a of the surface table 5 downwardly from the lower end of the housing 4. A final (terminal)-end side gear 7b is fixed to a portion of the saw blade shaft 1a entering the gear case 2b.

As shown in FIG. 6, inside the gear case, first and second gears 7c and 7d forming an intermediate gear connecting the start-end side gear 7a and the final-end side gear 7b and a power transmission mechanism 15 forming the intermediate gear shaft 14 are accommodated. These first and second gears 7c and 7d are fixedly mounted side by side on the intermediate gear shaft 14.

Both the end portions of the intermediate gear shaft 14 are supported to the gear case 2b through the bearings 16 and 17, respectively. Further, in the circular saw of the present embodiment, the right end portion of the intermediate gear shaft 14 is supported by a needle bearing, for example, which has a small diameter but does not receive thrust load because it is impossible to have a vertical space thereof in its structural reason. On the other hand, the left end portion of the intermediate gear shaft 14 is supported by a radial bearing, for example, which can be subjected to the thrust load.

The circular saw blade 1 of the circular saw 100 having the structure mentioned above is rotated by the power of the motor 6 which is transmitted to the saw blade shaft 1a through the start-end side gear 7a, the first gear 7c, the second gear 7d and the final-end side gear 7b in this order.

More specifically, the power transmission mechanism 15 is constructed as follows. The start-end side gear 7a on the motor shaft 6a is formed as a helical gear integrally formed with the motor shaft 6a, and the first gear 7c meshed with the start-end side gear 7a is formed as a helical gear fixed integrally to the intermediate gear shaft 14 by means of key or press-fitting. Furthermore, the second gear 7d is a helical gear fixed integrally to the intermediate gear shaft 14, and the final-end side gear 7b meshed with the second gear 7d is formed as a helical gear fixed integrally to the saw blade shaft 1a by means of key or press-fitting.

Further, the first gear 7c has a pitch circle diameter larger than that of the second gear 7d, and the first and second gears 7c and 7d have tooth traces twisted in the same direction (rightward direction with respect to the intermediate gear shaft 14 in this embodiment) and mounted on the intermediate gear shaft 14, respectively.

As mentioned above, by arranging the first and second gears 7c and 7d in a manner such that the tooth traces thereof are twisted in the same direction, the first and second gears 7c and 7d are meshed with the start-end side gear 7a and the final-end side gear 7b, respectively, and therefore, the thrust load is applied to the intermediate gear shaft 14 from the first gear 7c toward the second gear 7d, and the thrust load is also applied from the second gear 7d toward the first gear 7c, so that the thrust loads are denied from each other, thus reducing the thrust load to be applied to the intermediate gear shaft 14. Accordingly, since the thrust load applied to the bearings 16 and 17, the life time of these bearings 16 and 17 can be elongated.

In addition, since the bearing 17 as the needle bearing is not received with the thrust load, it is designed that the tooth trace of the first gear 7c with respect to the intermediate gear shaft 14 is twisted rightward, and its twisted angle becomes larger than the twisted angle of the tooth trace of the second gear 7d with respect to the intermediate gear shaft 14. As a result, by the arrangement in which the thrust load applied to the intermediate gear shaft 14 is directed toward the bearing 16 as a radial bearing, any thrust load is not applied to the bearing 17 as a needle bearing and the thrust load can thus be surely received by the bearing 16.

As mentioned above, while reducing the thrust load, the thrust load is received by the bearing 16, so that the durability of the bearing 17 can be elongated.

Furthermore, the bearing 17 as the needle bearing is composed of an inner race (ring) and an outer race (ring) both formed of alloy steel plate, for example, and the outer peripheral surface of the inner race slides in the axial direction with respect to the inner peripheral surface of the outer race. Generally, the needle bearing has a thin thickness in comparison with the radial bearing, so that the needle bearing may be disposed in a relatively narrow space. In this embodiment, the bearings 17 and 13 as needle bearings are mounted to the right end portion of the intermediate gear shaft 14 and the right end portion of the saw blade shaft 1a. Further, the needle bearing 17 of the present embodiment does not receive the thrust load in its structural characteristic.

On the other hand, the bearing 16 as the radial bearing is composed of an inner race 31, an outer race 32, a plurality of bolls (spherical members) 33 and a retainer 34 in such a manner that a several balls 33 are arranged between the inner race 31 and the outer race 32 and the respective balls 33 are arranged so as not to contact each other with a constant space by the retainer 34 so as to perform smooth rolling motion of the balls. Furthermore, the radial bearing 16 supporting one end portion of the intermediate gear shaft 14 includes a resisting member 35 between the inner race 31 and the outer race 32 so as to restrict the rotation of the inner race 31. The resisting member 35 is formed of an elastic material such as rubber covering a steel plate core metal 36, for example. According to such structure, the rotation of the intermediate gear shaft 14 is restricted, and at the cutting starting time or cutting ending time by the circular saw blade 1, a sound beating the tooth surface by backlash between the gears, more specifically, between the start-end side gear 7a and the first gear 7c and between the second gear 7d and the final-end side gear 7b can be reduced.

1. An electric cutting tool comprising: a body portion including a driving portion for rotating a circular saw blade and a power transmission mechanism for transmitting a power of the driving portion to the circular saw blade; and a surface table supporting the body portion, in which the circular saw blade is supported by a shaft that is disposed between a shaft of the driving portion and the surface table,
wherein the power transmission mechanism is provided with a pair of helical gears arranged on a same shaft, and the paired helical gears have tooth traces directed in a same direction.

2. The electric cutting tool according to claim 1, wherein the paired helical gears are mounted to an intermediate gear shaft, in which one of the paired helical gears has a tooth trace angle larger than that of another one of the helical gears, and a bearing that receives a thrust load is provided for an end portion of the intermediate gear shaft on another one helical gear side.

3. The electric cutting tool according to claim 1, wherein the paired helical gears are mounted to an intermediate gear shaft, the intermediate gear shaft is provided with a bearing supporting the intermediate gear shaft and receiving a thrust load applied thereto, the bearing is composed of a circular inner race, a circular outer race and a plurality of spherical members disposed between the inner and outer races, and a resisting member for restricting rotation of the inner race is disposed between the inner and outer races.

4. The electric cutting tool according to claim 2, wherein the paired helical gears are mounted to an intermediate gear shaft, the intermediate gear shaft is provided with a bearing supporting the intermediate gear shaft and receiving a thrust load applied thereto, the bearing is composed of a circular inner race, a circular outer race and a plurality of spherical members disposed between the inner and outer races, and a resisting member for restricting rotation of the inner race is disposed between the inner and outer races.
